(19) United States
(12) Patent Application Publication
(10) Pub. No.: US 2014/0236597 A1
(43) Pub. Date: Aug. 21, 2014

(54) SYSTEM AND METHOD FOR SUPERVISED CREATION OF PERSONALIZED SPEECH SAMPLES LIBRARIES IN REAL-TIME FOR TEXT-TO-SPEECH SYNTHESIS

(71) Applicant: VivoText Ltd., Misgav (IL)

(72) Inventors: Yossef BEN EZRA, Rehovot (IL); Shai NISSIM, Tel-Aviv (IL); Gershon SILBERT, Tel-Aviv (IL)

(73) Assignee: VIVOTEXT LTD., Misgav (IL)

(21) Appl. No.: 14/261,981

(22) Filed: Apr. 25, 2014

Related U.S. Application Data
(63) Continuation-in-part of application No. 13/686,140, filed on Nov. 27, 2012, now Pat. No. 8,775,185.
Application No. 13/686,140 is a continuation of application No. 12/532,170, filed on Sep. 21, 2009, now Pat. No. 8,340,967.
(60) Provisional application No. 61/816,176, filed on Apr. 26, 2013.
(60) Provisional application No. 60/907,120, filed on Mar. 21, 2007.

(51) Int. Cl. G10L 15/26; G10L 15/06

(52) U.S. Cl. CPC G10L 15/26; G10L 15/06
USPC 704/235

(57) ABSTRACT

A system and method for supervised creation of a speech samples library for text-to speech synthesis are provided. The method includes tracking at least one speech unit in an existing speech samples library to determine if the existing speech samples library achieves a desired quality; receiving at least one speech sample; analyzing the at least one received speech sample to identify at least one speech unit necessitated to obtain the desired quality of the speech samples library; and storing the at least one necessary speech unit in the speech samples library.

### CROSS-REFERENCE TO RELATED APPLICATIONS

This application claims the benefit of U.S. Provisional Application No. 61/816,176 filed on Apr. 26, 2013. The application is also a continuation-in-part application of U.S. application Ser. No. 13/686,140 filed Nov. 27, 2012, now allowed. The Ser. No. 13/686,140 application is a continuation of U.S. patent application Ser. No. 12/532,170, now U.S. Pat. No. 8,340,967, having a 371 date of Sep. 21, 2009. The Ser. No. 12/532,170 application is a national stage application of PCT/IL2008/00385 filed Mar. 19, 2008, which claims priority from U.S. Provisional Patent Application No. 60/907,120, filed on Mar. 21, 2007. The contents of the above Applications are all incorporated herein by reference.

### TECHNICAL FIELD

The present invention relates generally to the generation of a speech samples library utilized for text-to-speech (TTS) synthesis and, more specifically, to supervised creation of speech samples libraries for TTS synthesis customized based on a user's expressive speech.

### BACKGROUND

Several systems known in the art provide speech samples libraries for text-to-speech (TTS) synthesis. These speech samples libraries are typically equipped with speech units with diverse utterances based on a variety of musical parameters. The musical parameters can include, for example, different pronunciations of a given word that may result from characteristics of the speaker such as gender, accent, dialect, etc. The quality of these collections of speech samples is typically measured by how natural or human-like the synthesized speech sounds. Thus, such measures of quality are typically evaluated respective of a phonetic completeness, a phonemic completeness, and an optimal variety of musical attributes.

The existing art features techniques for synthesis of customized expressive speech. Such synthesis may be produced respective of TTS techniques. In order to achieve such synthesis, a customized speech samples library is required to be created respective of a user's voice. The creation of such customized speech sample libraries depends in part on unsupervised and unstructured speech. The difficulty arising from such speech sample libraries is that a desired threshold of quality suitable for generating expressive TTS voice cannot be supervised in real time.

It would therefore be advantageous to overcome the limitations of the prior art by providing an effective way for handling the supervision of the creation of a speech samples library reaching a desired quality threshold suitable for generating customized expressive speech.

### SUMMARY

Certain exemplary embodiments include a system and method for supervised creation of a new speech samples library for text-to-speech (TTS) synthesis. The method comprises tracking at least one speech unit in an existing speech samples library to determine if the existing speech samples library achieves a desired quality; receiving at least one speech sample; analyzing the at least one received speech sample to identify at least one speech unit necessitated to obtain the desired quality of the speech samples library; and storing the at least one necessary speech unit in the speech samples library.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of a system for creating personalized speech samples libraries utilized to describe various embodiments.

FIG. 2 is a flowchart illustrating the supervised creation of a personalized speech samples library according to an embodiment.

FIG. 3 is a flowchart illustrating determination of whether a desired quality has been achieved according to an embodiment.

FIG. 4 is a flowchart illustrating determination of priority according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

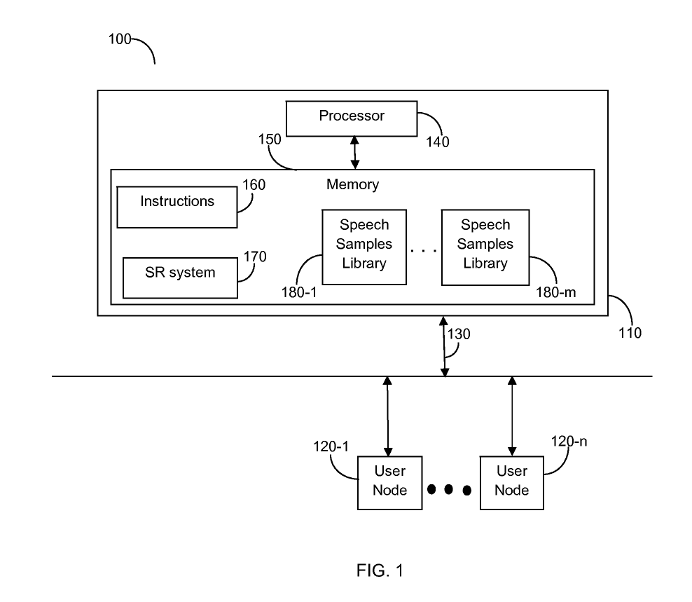

FIG. 1 is an exemplary and non-limiting schematic diagram of a system 100 for creating personalized speech samples libraries utilized to describe the various embodiments. A server 110 is optionally connected to one or more user nodes 120-1 through 120-n (for the sake of simplicity and without limitation, user nodes 120-1 through 120-n may be referred to individually as a user node 120 or collectively as user nodes 120) via an interface 130. Such a user node 120 may be, but is not limited to, a computer node, a personal computer (PC), a notebook computer, a cellular phone, a smartphone, a tablet device, a wearable and device, and so on. The server 110 typically contains several components such as, a processor or processing unit 140, and a memory 150. The interface 130 may be a network interface providing wired and/or wireless connectivity for a local area network (LAN), the Internet, and the like. Alternatively or collectively, the network interface 130 may be a serial bus, for example, universal serial bus (USB) for connecting peripheral devices.

The memory 150 further contains instructions 160 executed by the processor 140. The system 100 optionally includes a speech recognition (SR) system 170 that may be an integral part of the memory 150, or a separate entity coupled to the server 110. According to one embodiment, the server 110 is configured to identify, using the the SR system 170, speech samples pronounced by a user. According to another embodiment, the server 110 may be configured to perform digital signal processing (DSP) when the pronunciation is inconsistent. This inconsistency may be expressed, for example, in a sound volume, a speed of the pronunciation, and a tone of speech.

According to yet another embodiment, the server 110 is further configured to receive speech samples containing speech units through, for example, the interface 130. A speech sample may be a word, a phrase, a sentence, etc. A speech unit is a distinct unit of sound in a specified language or dialect used to distinguish one word from another. As an example p, b, d, and t, may distinguish between the English words pad, pat, bad, and bat. Each speech unit can be classified to a phoneme, a bi-phone, or a tri-phone. A phoneme is the basic unit of a language's phonology, which is combined with one or more phonemes to form meaningful units of bi-phones or tri-phones.

The system 100 includes one or more speech samples libraries 180-1 through 180-m (for the sake of simplicity and without limitation, speech samples libraries 180-1 through 180-m may be referred to individually as a speech samples library 180 or collectively as speech samples libraries 180) that may be an integral part of the memory 150, or a separate entity coupled to the server 110. Each speech samples library 180 contains personalized speech samples of speech units. Moreover, each speech samples library 180 may maintain information to be used for TTS synthesis.

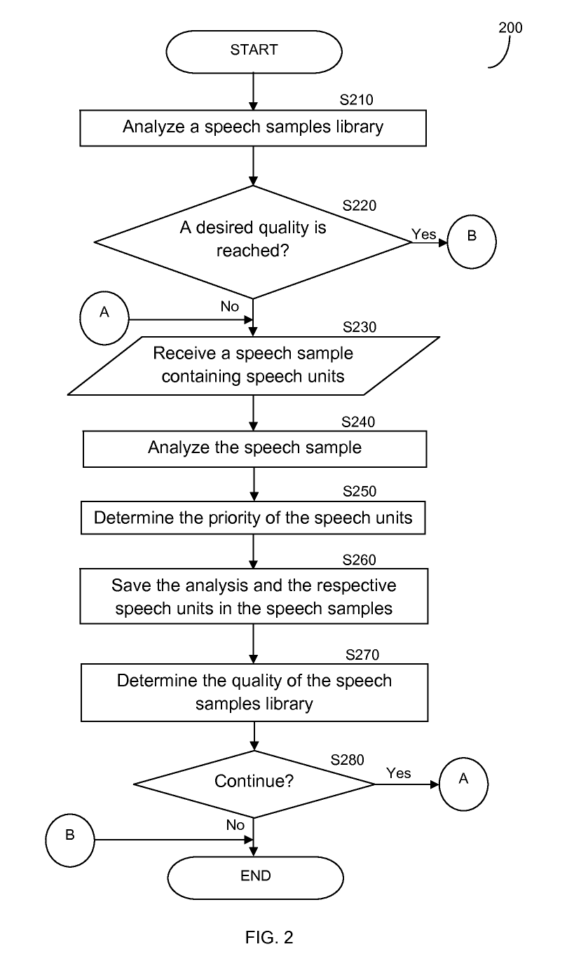

The server 110, in an embodiment, is configured to analyze each speech samples library 180. The server 110 typically identifies one or more speech units stored in the speech samples library 180 as well as the speech units that are missing and, thus, must be added. This identification is usually performed respective of a threshold of speech units required to reach a desired quality. When a speech sample is received, the server 110 is then configured to analyze the speech sample and the speech units comprised within. The analysis may include, for example, identification of neighbors of each speech unit in the speech sample, determination of a location of each speech unit in the speech sample, analysis of musical parameters of each speech unit, etc. The analysis process is discussed further herein below with respect to FIG. 2.

Moreover, the server 110 may also determine a quality of the speech samples. The speech units are stored in the speech samples library 180 under the supervision of the server 110 in real-time respective of a priority determined for each speech unit. The server 110 takes into consideration the analysis results to determine the priority of each speech unit. The supervised creation of the speech samples library 180 assists the server 110 in determining whether the speech samples library 180 has reached the desired quality. The process of analyzing a speech samples library and the speech samples contained therein to perform supervised creation of a speech samples library 180 of a desired quality is discussed further herein below with respect to FIG. 2.

FIG. 2 shows an exemplary and non-limiting flowchart 200 describing the supervised creation of a personalized speech samples library according to an embodiment. A personalized speech samples library is a speech samples library that achieves a desired quality. The desired quality may be, e.g., a level of quality that is predefined, a level of quality decided by a user in real time, and the like. In this embodiment, the personalized speech samples library is constructed based on speech samples contained in an existing speech samples library. In various other embodiments, a personalized speech samples library may be constructed without utilizing an existing speech samples library.

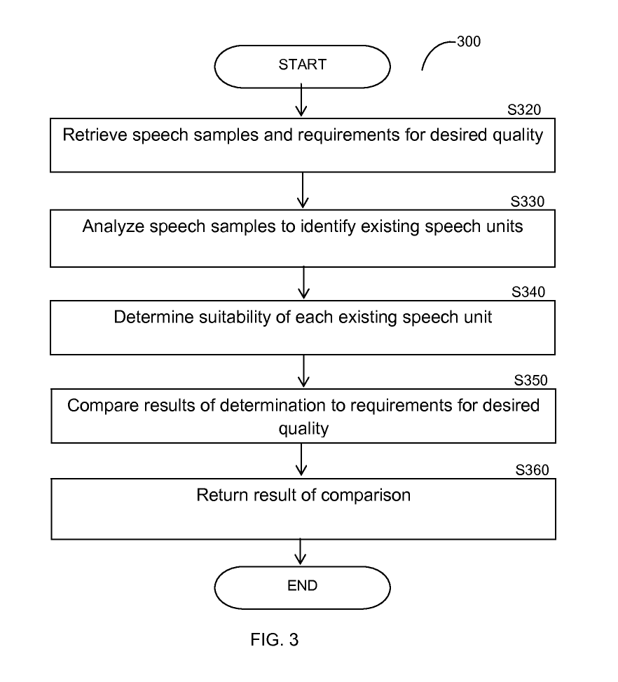

In S210, upon receiving a request to create a personalized speech samples library, one or more speech units stored in an existing or preconfigured speech samples library (e.g., speech samples library 180) are tracked for analysis. In an embodiment, a server (e.g., server 110), tracks the one or more speech units. In S220, it is checked whether the speech samples library has reached a desired quality and, if so, execution terminates; otherwise, execution continues with S230. Determination of whether a speech samples library has achieved a desired quality is discussed further herein below with respect to FIG. 3.

In S230, one or more speech samples are received. In an embodiment, the one or more speech samples are received from the speech samples library. The speech samples library may lack one or more speech units that are necessary to achieving a desired quality. A speech sample may be, but is not limited to, a word, a sequence of words, a sentence, and the like. In an embodiment, the identities of speech units that are missing respective of the speech units existing in the speech samples library are determined. This determination may further include determining a threshold of speech units that are required for the desired quality. A speech unit may be, but is not limited to, a phoneme, a bi-phone, a tri-phone, and the like.

According to one embodiment, the speech samples may be received through a speech recognition (SR) system (e.g., SR system 170). According to another embodiment, a request is sent to a user to pronounce one or more speech samples. The request may be sent through an appropriate interface (e.g., interface 130). Moreover, the received speech samples may be sent back in real-time to verify that the identification of such speech samples was correct.

In S240, one or more speech units of the received speech samples are analyzed. In an embodiment, the speech unit's neighbors within each speech sample are identified. A neighbor is a speech unit that precedes or follows the analyzed speech unit when the speech units of a speech sample are arranged in a sequential order (e.g., according to location within the speech sample). In an embodiment, neighbors only include speech units that immediately precede or follow the analyzed speech unit. In another embodiment, a parameters analysis is performed for each speech unit. Such an analysis may include, but is not limited to, identification of musical parameters, such as, pitch characteristics, duration, volume, and so on.

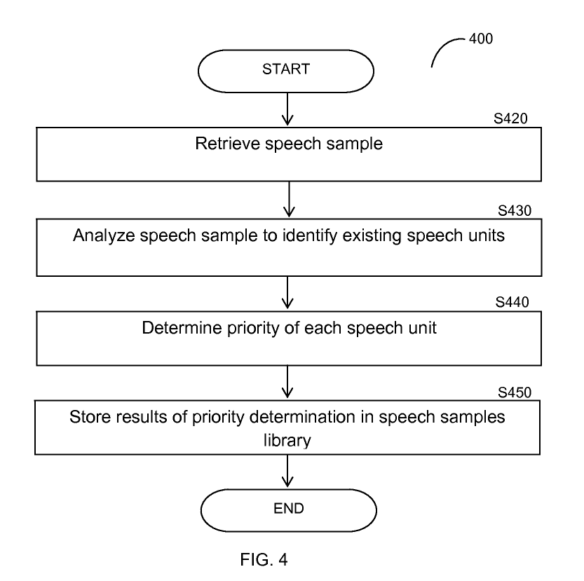

In S250, a priority of the speech samples and the respective speech units is determined. A priority may be, but is not limited to, one of several categories (e.g., low, medium, or high), a numerical value associated with levels of priority (e.g., zero through ten, wherein zero represents the lowest priority and ten represents the highest priority), and so on. Determination of priority is discussed further herein below with respect to FIG. 4.

In S260, the analysis and its respective speech units are stored in the speech samples library. The speech units are typically stored respective of the priority of those speech units or of speech samples containing the speech units. In an embodiment, speech units with higher priority are stored earlier in a sequential order than speech units with lower priority.

In S270, the quality of the speech samples library is determined respective of the analysis made for each speech unit and the respective determined priority. A value representing the quality may be displayed to the user through the interface. In S280, it is checked whether there are additional speech units that are required to be added and if so execution continues with S230; otherwise, execution terminates.

FIG. 3 illustrates an exemplary and non-limiting flowchart S220 for determination of whether a desired quality has been achieved by a speech samples library according to an embodiment.

In S310, speech samples and requirements for desired quality are retrieved. A speech sample may be, but is not limited to, a word, a sequence of words, a sentence, and the like. In an embodiment, the speech samples may be retrieved from an existing speech samples library. In another embodiment, the speech samples may be retrieved from an input received by a user, an electronic sound database, and the like. The requirements for desired quality may be, e.g., a minimum number of speech units, a set of required speech units, a set of speech samples containing all required speech units, and the like. A speech unit may be, but is not limited to, a phoneme, a bi-phone, a tri-phone, etc.

In S320, the retrieved speech samples are analyzed to determine existing speech units within each speech sample. In S330, the existing speech units are analyzed to determine the suitability of each speech unit. Suitability may be determined based on musical parameters of the speech unit including, but not limited to, volume, clarity, pitch, tone, duration, etc. Suitability of a speech unit may be, e.g., predefined, or may be determined by the user in real-time. In embodiments where suitability is determined by a user in real-time, the speech units may be displayed and played on a user node, thereby enabling the user to decide whether each speech unit is suitable according to his or her preferences.

In an embodiment, suitable speech units are compiled in a list or number of speech units. In that embodiment, the results of the suitability determination may be returned as the list or number of speech units. Thus, in that embodiment, unsuitable speech units are excluded from the results of the suitability determination. As a non-limiting example, if a speech sample of the word “incredulous” is analyzed (a word that includes four phonemes that, for purposes of the example, each considered to be a speech unit), and three of the speech units are determined to be suitable, the results of the suitability analysis would only include those three suitable speech units.

In S340, the results of the suitability determination in S330 are compared to the requirements for desired quality. In S350, the results of the comparison are returned. It should be noted that the comparison results utilized in the determination if the suitability has been achieved as required by the process discussed above.

FIG. 4 is an exemplary and non-limiting flowchart S250 illustrating determination of priority according to an embodiment. A priority in the context of the disclosed embodiments may be, but is not limited to, a classification within one of several categories (e.g., low, medium, high, and the like), a numerical value associated with levels of priority (e.g., zero through ten, wherein zero represents the lowest priority and ten represents the highest priority), and so on.

In an embodiment, the priority represents the degree of importance that a speech unit has within a given speech samples library (e.g., speech samples library 180). Speech units demonstrating particularly unique features respective of other speech units may be determined as higher priority, since such unique speech units typically contribute more to the quality of a speech samples library than less unique speech units.

In S410, the speech sample is retrieved. In an embodiment, the speech sample is retrieved from, e.g., a speech samples library 180. In S420, the speech sample is analyzed to identify existing speech units within the speech sample.

In S430, the priority of each speech unit is determined. The priority may be determined, for example, respective of the analysis and the desired quality of the speech samples library. In an embodiment, the priority may be determined respective of a quality level of the received speech sample. Specifically, speech units associated with speech samples having poor quality are considered low priority, while speech units associated with speech samples having high quality are considered high priority. As a non-limiting example, speech units of clear sounding words will get higher priority than speech units of words whose respective sounds are muddled or otherwise distorted.

In a further embodiment, the priority of speech units may be determined respective of a variety of musical parameters of such speech units. In that embodiment, existence of a variety of musical parameters of such speech units may also lead to determination of a high priority speech unit. As a non-limiting example, the quality of the speech samples library may depend on, among other things, existence of a wide range of pitch characteristics of the speech samples.

In another embodiment, the priority may be determined respective of a significance of the speech units. In that embodiment, significant speech units may be considered high priority. The significance of a speech unit may be determined respective of a frequency of occurrence of the speech unit in a natural language speech corpus. The significance may also be reflected upon existence of one or more alternative speech units found in the speech samples library. Absence of such alternative speech units may lead to determination of a high significance speech unit and, thus, would result in a high priority speech unit.

In S440, the results of the priority determination are stored in a speech samples library. In an embodiment, these results are associated with the respective speech samples in the speech samples library.

The processes described herein with references to FIGS. 2-4 may be performed by the server 110. In another embodiment, a user node 120 may be configured to execute these processes.

It should be appreciated that the preceding embodiments for determining priority do not limit the methods available for determining the priority. Specifically, any of the above methods of embodiments may be combined with each other and/or with other methods for determining the priority without departing from the scope of the disclosed embodiments. As an example, the priority may be determined based on both the significance of speech units and the variety of musical parameters. In such combinations, the priority may be determined to be high if, e.g., any of the methods used for determining priority yields a high priority result, or if an average of numerical values for priority yields a high priority result.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for supervised creation of a new speech samples library for text-to-speech (TTS) synthesis, comprising:
tracking at least one speech unit in an existing speech samples library to determine if the existing speech samples library achieves a desired quality;
receiving at least one speech sample;
analyzing the at least one received speech sample to identify at least one speech unit necessitated to obtain the desired quality of the speech samples library; and
storing the at least one necessary speech unit in the speech samples library.

2. The computerized method of claim 1, wherein the desired quality is determined respective of a predefined threshold.

3. The computerized method of claim 1, wherein the at least one speech unit is any of: a phoneme, a bi-phone, and a tri-phone.

4. The computerized method of claim 1, further comprising:
analyzing at least one musical parameter related to the at least one speech unit.

5. The computerized method of claim 4, wherein the at least one musical parameter is any of: pitch characteristics, duration features, and a sound volume.

6. The computerized method of claim 1, wherein the analysis of the at least one speech sample further comprises:
determining a quality level of the at least one received speech sample.

7. The computerized method of claim 6, wherein the identification of the at least one speech unit further comprises at least one of: analyzing a location of the at least speech unit within the at least one speech sample, analyzing neighbors of the at least one speech unit in the at least one speech sample, and analyzing a significance of the at least one speech unit.

8. The computerized method of claim 7, wherein the significance of the at least one speech unit is determined based on at least one of: a frequency of occurrence of the at least one speech unit in the speech samples library, a frequency of occurrence of the at least one speech unit in a natural language speech corpus, an existence of alternative speech units, a lack of any alternative speech units.

9. The computerized method of claim 1, further comprising:
sending a request to at least one user to pronounce the at least one speech sample.

10. The computerized method of claim 9, further comprising:
performing digital signal processing (DSP) when the at least one pronounced speech sample is inconsistent.

11. The computerized method of claim 1, wherein the at least one speech sample is at least one of: a word, a phrase, and a sentence.

12. A non-transitory computer readable medium having stored thereon instructions for causing one or more processing units to execute the method according to claim 1.

13. A system for supervised creation of a speech samples library for text-to-speech (TTS) synthesis, comprising:
a processor; and
a memory, wherein the memory contains instructions that, when executed by the processor, configure the system to:
track at least one speech unit in an existing speech samples library to determine if the existing speech samples library achieves a desired quality;
receive at least one speech sample;
analyze the at least one received speech sample to identify at least one speech unit necessitated to obtain the desired quality of the speech samples library; and
store at least the one necessary speech unit in the speech samples library.

14. The system of claim 13, wherein the system further comprises:
a speech recognition (SR) system, wherein the SR system is configured to identify at least one speech sample pronounced by a user.

15. The system of claim 13, wherein the system is further configured to:
display a value representing a quality of the speech samples library via an interface.

16. The system of claim 15, further configured to:
return the at least one received speech samples to verify a correct identification of the at least one identified speech sample.

17. The system of claim 13, wherein the desired quality is determined respective of a predefined threshold.

18. The system of claim 13, wherein the at least one speech unit is any of: a phoneme, a bi-phone, and a tri-phone.

19. The system of claim 13, wherein the system is further configured to:
analyze at least one musical parameter related to the at least one speech unit.

20. The system of claim 19, wherein the at least one musical parameter is at least one of: pitch characteristics, duration features, and a sound volume.

21. The system of claim 13, wherein the identification of the at least one speech unit further comprises at least one of: analyzing a location of the at least speech unit within the at least one speech sample, analyzing neighbors of the at least one speech unit in the at least one speech sample, and analyzing a significance of the at least one speech unit.

22. The system of claim 21, wherein the significance of the at least one speech unit is determined based on at least one of: a frequency of occurrence of the at least one speech unit in the speech samples library, a frequency of occurrence of the at least one speech unit in a natural language speech corpus, an existence of alternative speech units, a lack of any alternative speech units.

23. The system of claim 13, wherein the system is further configured to:
send a request to at least one user to pronounce the at least one speech sample.

24. The system of claim 23, wherein the system is further configured to:
perform digital signal processing (DSP) when the at least one pronounced speech sample is inconsistent.

25. The system of claim 13, wherein the at least one received speech sample is any of: a word, a phrase, and a sentence.
